(19) United States
(12) Patent Application Publication
(10) Pub. No.: US 2014/0328578 A1
(43) Pub. Date: Nov. 6, 2014

(54) CAMERA ASSEMBLY, SYSTEM, AND METHOD FOR INTELLIGENT VIDEO CAPTURE AND STREAMING

(71) Applicants: Thomas Shafron, Miami Beach, FL (US); David Shafron, Miami Beach, FL (US)

(72) Inventors: Thomas Shafron, Miami Beach, FL (US); David Shafron, Miami Beach, FL (US)

(21) Appl. No.: 14/245,372

(22) Filed: Apr. 4, 2014

Related U.S. Application Data
(60) Provisional application No. 61/809,594, filed on Apr. 8, 2013.

(51) Int. Cl. H04N 21/63; H04N 5/917

(52) U.S. Cl. CPC H04N 21/63; H04N 5/917
USPC 386/328

(57) ABSTRACT

A camera assembly, system, and method for intelligent video capture and streaming. The camera assembly is configured to continuously capture video data of live events in a data buffer, and is further configured to stream the video data to at least one remote recipient over a network, upon receiving a trigger signal. The trigger signal may be generated by a control system as determined by a rules engine, may be relayed through other components, and may be received over the network, such as through an external device. After receiving the trigger signal, the camera assembly begins streaming video data from the data buffer at a moment in buffered time. The moment in buffered time may be determined by a timestamp associated with the trigger signal where the trigger signal is received over the network from events generated by external device(s). The rules engine also notifies the camera assembly when to terminate streaming.

### CLAIM OF PRIORITY

The present application is based on and a claim to priority is made under 35 U.S.C. Section 119(e) to provisional patent application currently pending in the U.S. Patent and Trademark Office, having Ser. No. 61/809,594 and a filing date of Apr. 8, 2013, the entirety of which is incorporated herein by reference.

### BACKGROUND OF THE INVENTION

1. Field of the Invention

This invention is directed to a camera assembly, system, and method for intelligent video capture and streaming. Specifically, the camera assembly of the present invention continuously sends video data to a data buffer. Remote processor(s) implement a rules engine to coordinate the issuance of a trigger signal to initiate streaming of the buffered video data to a remote recipient in response to a desired condition. The stream of video data begins at a recorded (or “buffered”) moment in time that precedes the current time, and for which a sufficient duration of video data has been stored in the data buffer. The rules engine also notifies the camera assembly when to terminate streaming.

2. Description of the Related Art

The field of video monitoring and surveillance has increasingly been adopted by both public and private sectors. With the lowering of the cost of cameras and networking devices, and the increasing availability of network connectivity, the use of networked cameras and surveillance systems has been growing steadily at homes, businesses, and government facilities. Most network camera and network video recorder (NVR) systems today continuously stream video from the cameras to the NVR at all times and for recording purposes either: decide what/when to record based on a schedule; constantly record all the streamed video data; or record based on certain events. This results in both wasted network bandwidth and device storage. When the recording system is located over a third party network, such as the Internet, this wasted bandwidth consumption due to the constant streaming becomes prohibitively expensive and results in the end user either reducing the quality of the video being streamed or reducing the number of cameras streaming video data or both to compensate for the high bandwidth costs.

Another current system-level option is to place the intelligence of when to record primarily on the camera. A primary disadvantage of placing the intelligence entirely on a camera is that the camera is very limited as to rules capability for event recording, such as to incorporate events or trigger signals from other external devices and systems. For example, in one scenario it may be desirable for a camera to begin recording if an alarm system is “armed” and a particular door near the camera is opened. This would be difficult to accomplish in such a system because the camera would have to be notified of the alarm system state change, as well as the status of the door sensor. In addition, the camera may not be able to sufficiently communicate with these other sensors, devices, databases, services, applications, etc. in order to receive event notifications due to network limitations, protocols, security/firewall configurations, etc. Further, as the number of cameras on a system is expanded, managing the configurations on each camera and the systems in communication directly with the cameras for events becomes increasingly difficult to manage and support. Further still, a sophisticated rules engine would be required to be incorporated within the camera, thus increasing the cost of the camera and overall local system as well.

Thus, there is a need for a cost-effective and intelligent camera assembly, system, and method that places the intelligence of what video to stream and when to commence and terminate video streaming from any camera assemblies primarily on the external system to reduce system complexity as well as bandwidth consumption from streaming video and in turn, to increase system security and flexibility, integrate with a range of devices, sensors, databases, services and applications, and to enable accurate, customized attention to important local timing issues and account for potential inherent system delays.

### SUMMARY OF THE INVENTION

The present invention addresses the existing needs and deficiencies described above by providing for a camera assembly, system, and method for intelligent video capture and streaming, which is both cost-effective and accurate as to the manner and timing of the initiation of a recording.

Accordingly, in initially broad terms, at least one embodiment of the present invention comprises a camera assembly for intelligent video capture and streaming. The camera assembly may include a lens and imager, a housing, an encoding module, a data buffer, a streaming module, and a network interface.

The lens and imager are cooperatively structured to continuously capture visual data, which may include video data and/or snapshots, of live events as they occur, as well as related metadata. In some embodiments, the camera assembly may further comprise a microphone structured to continuously capture audio data as well as other sensors such as passive infrared for motion and lux sensors for light. Video and/or audio data and/or one or more snapshots and/or metadata are then continuously buffered by the encoding module to a data buffer. The encoding module may also be structured and/or configured to store the video and/or audio data and/or one or more snapshots and/or metadata in a compressed format. The data buffer may comprise at least a portion of volatile or non-volatile storage or memory, and may be structured as a FIFO, circular buffer, bip buffer, or other data structure(s) appropriate for the temporary and continuous buffering of video and/or audio data and/or one or more snapshots and/or metadata.

The streaming module and network interface are cooperatively structured and/or configured to stream the video data from the data buffer to at least one remote recipient, which may then record the incoming stream of data. Importantly, the streaming module comprises appropriate internal logic and/or components to begin transmitting historical video and/or audio data and/or one or more snapshots and/or metadata from the data buffer at a recorded or “buffered” moment in time prior to the current time, and for which a sufficient duration of video and/or audio data and/or one or more snapshots and/or metadata has been correspondingly buffered. Alternatively, the streaming module may also begin streaming the video and/or audio data and/or one or more snapshots and/or metadata in real time, depending on its configuration and/or the instruction received, such as from the remote recipient or an external system or device. In some embodiments, the streaming module may transmit snapshot image(s) corresponding to a frame or time in history in conjunction with or instead of transmitting the video and/or audio data and/or one or more snapshots and/or metadata. The streaming module may further be configured to convert the video and/or audio data and/or one or more snapshots and/or metadata into a streaming format and/or for use with various streaming protocols. The network interface may comprise wired or wireless interfaces structured and configured to communicate with a remote recipient and/or to receive a trigger signal. The streaming module may begin streaming the video and/or audio data and/or one or more snapshots and/or metadata upon receiving an external trigger signal from the network. In a preferred embodiment, the trigger signal is generated by a control system that generates the trigger signal based upon a rules system implemented by the control system to handle events of all types sent to the control system by any sensors, devices, databases, services, applications, etc. Alternatively, the streaming module may also begin streaming the video and/or audio data and/or one or more snapshots and/or metadata upon generating an internal trigger signal, such as from an event detection module or other sensor module.

As such, an event detection module may be structured and/or configured to detect a change in the live video and/or audio data and/or one or more snapshots and/or metadata being recorded. The event detection module may comprise of a video analytics module and any number of sensors and scanners of any type, including but not limited to, infrared or visible optics, radio, sound, vibration, motion, temperature, and/or magnetism sensors configured to detect changes in the camera assembly's surrounding environment. Upon detection of a change in the environment associated with the time of the environmental change, a trigger signal may then be sent to the streaming module to begin streaming the video and/or audio data and/or one or more snapshots and/or metadata (in which the streaming module may dynamically place a key frame at the beginning of the stream). In other embodiments, the trigger signal may be sent to begin streaming the video and/or audio data and/or one or more snapshots and/or metadata to begin from the time of a prior or earlier event. In a primary embodiment, an event signal containing information about the environment change can be sent from the camera to an external system that executes the rules engine which may in turn send a trigger signal to one or more cameras to initiate streaming at the current time or from an earlier time such that the data has been retained in the camera's data buffer.

Another embodiment of the present invention may also be directed to a system for intelligent video capture and streaming. The system may comprise at least one camera assembly, at least one remote recipient, a control center and an optional operator interface, and at least one external device, database, service or application communicably connected over a network. The network can comprise a variety of components, architectures, and protocols including, but not limited to, TCP/IP, wired, wireless, ZWAVE, ZIGBEE, MODBUS, BACNET, serial, RS-485 etc. The network can also comprise multiple ones of the aforementioned types connected together with gateways, routers or the like to translate communications between them, and may also include multiple ones of the same kinds of such network types.

The camera assembly of the inventive system may comprise a camera assembly similar to the one described above, though not necessarily limited to such an embodiment. Accordingly, the camera assembly may be structured to continuously buffer video and/or audio data and/or one or more snapshots and/or metadata in a data buffer. The camera assembly may also be structured to stream the video and/or audio data and/or one or more snapshots and/or metadata to at least one remote recipient over the network, upon receiving a trigger signal that may be generated, in a preferred embodiment, externally by a control system that generated the trigger signal based upon conditions being met within a set of rules implemented by the control system to handle events of all types sent to the control system by any sensors, devices, databases, services, applications, etc., or alternatively, internally by the camera assembly such as through event detection including but not limited to motion and/or object detection and/or recognition, or generated externally and received from an external device. The video and/or audio data and/or one or more snapshots and/or metadata may begin streaming from the data buffer at a recorded time prior to the current time, and for which a sufficient duration of data has correspondingly been stored in the data buffer.

The remote recipient may be structured and/or configured to receive the video and/or one or more snapshots and/or audio data and/or metadata from the camera assembly, for display to a user and/or for recording. In some embodiments, the remote recipient may, in the manner of acting as an external device, be able to access video and/or audio data and/or one or more snapshots and/or metadata from the camera assembly data buffer or other storage, the control center, or other external devices described below, such as to affect playback and change configurations of the various devices for video analytics, etc.

The external device(s) may be structured and/or configured to transmit an event signal to a control center, upon the occurrence of some condition event. The trigger signal that initiates the camera assembly's stream may contain a timestamp that corresponds with the condition event, or with the transmission or reception of such event signal, or with a designated amount of time (seconds, milliseconds, etc.) before the event or trigger signal was sent or received, determined by the external device, the camera assembly and/or by the control center described below. Examples of an external device include, but are not limited to an alarm monitoring control panel, various sensors, various state change detection and control devices, applications running on computers or embedded devices, user input through an application on a device, data from databases, cloud services (such as weather etc.) or user input through an application or device.

The control center may comprise at least one computer structured and/or configured to implement and/or execute a rules engine which coordinates the issuance of the trigger signal, upon a desired condition. A desired condition may be set to comprise a set of logic conditions, such as the current state of various external devices, data sources, user input, cloud based and other services, applications, etc., or state changes thereof. A given desired condition may then result in a trigger signal being transmitted to a given camera assembly, in order to begin streaming of the video and/or audio data and/or one or more snapshots and/or metadata. The rules engine may further be able to dictate which, or if all, remote recipient(s) will be receiving the streaming video and/or one or more snapshots and/or audio and/or metadata data from the given camera assembly, such as in embodiments with a plurality of remote recipients.

The rules engine may also be structured and/or configured to determine and/or instruct a given camera assembly to begin streaming video and/or audio data and/or metadata and/or one or more snapshots from a particular buffered moment in time prior to the current time or to a relative amount of time prior to the current time. The buffered time may be determined by a timestamp associated with the trigger signal, the timestamp may be set as: the time a condition event occurred on an external device; the time an event signal was transmitted by the external device; the time an event signal was received by the control center; the time a trigger signal was generated by the control center; the time the trigger signal was received by a camera assembly; the time determined by a key frame in the data buffer of a camera assembly; any relative offset to any of the listed options (such as a number of milliseconds before or after) or manually set by a user in as the remote recipient and/or connected to the control center through an operator interface. The rules engine may also be set to statically or dynamically instruct the camera assembly to begin streaming video and/or metadata and/or audio data and/or one or more snapshots a certain amount of time prior to the timestamp, such as to ensure that an event is not missed.

In a preferred embodiment, the rules engine also notifies the camera assembly how long to stream for. This can be done in any number of ways such as: continue streaming for a predetermined number of time (e.g., seconds, minutes, etc.), continue streaming until a certain time, continue streaming for as long as the camera receives messages to continue (heartbeat, or acknowledgements of received data by the remote recipient) or the camera assembly may continue streaming until it receives a stop streaming message. This notification can be in the same message as the trigger signal or sent in a different message or multiple messages. In at least one further embodiment, a user may be able to modify the rules engine, such as to set or modify desired conditions for the issuance of a trigger signal. Users may also be able to set or calibrate how the rules engine decides on the appropriate recorded time at which to begin the streaming of video and/or audio data and/or one or more snapshots and/or metadata. Accordingly, an operator interface may be implemented that allows a user to communicate with the control center, comprising software housed on the control center and/or on a separate application server.

The present invention further provides for methods for intelligent video capture and streaming. One method may comprise first buffering video data continuously in a data buffer on a camera assembly. The camera assembly then receives a trigger signal, which may (preferably) be generated by a control system running a rules engine, by an internal component, or generated by an external device and received by the camera assembly. The starting location of video data in the data buffer is then determined to be at a (buffered) moment in time prior to the current time. The particular “buffered” time for the starting location may be determined internally by the camera assembly, or may have been determined by an external device or may have been determined by the control center and is received as an instruction or timestamp as part of the received trigger signal or as a separate instruction or timestamp associated with the trigger signal.

### BRIEF DESCRIPTION OF THE DRAWINGS

For a fuller understanding of the nature of the present invention, reference should be had to the following detailed description taken in connection with the accompanying drawings in which:

FIG. 1 is a schematic diagram illustrating a camera assembly for intelligent video capture and streaming directed to the present invention.

FIG. 2 is a system diagram illustrating a system for intelligent video capture and streaming directed to the present invention.

FIG. 3 is a schematic diagram illustrating one example of a data buffer that is part of the one or more camera assemblies of FIGS. 1 and 2.

FIG. 4 is a flowchart illustrating one method for intelligent video capture and streaming directed to the present invention.

FIG. 5 is a flowchart illustrating another method for intelligent video capture and streaming directed to the present invention.

FIG. 6 is a flowchart illustrating another method for intelligent video capture and streaming directed to the present invention.

Like reference numerals refer to like parts throughout the several views of the drawings.

### DETAILED DESCRIPTION OF THE PREFERRED EMBODIMENT

As illustrated by the accompanying drawings, the present invention is directed to a camera assembly, system, and method for intelligent video capture and streaming. Specifically, the camera assembly of the present invention continuously buffers video data to a data buffer. Remote processor(s), based on a rules engine, coordinate the issuance of a trigger signal to the camera assembly to begin streaming video data to a remote recipient, in response to a desired condition. The streaming video data is configured to begin at a buffered moment in time that precedes the current time, and for which a sufficient duration of video data has been stored in the data buffer. The rules engine also notifies the camera assembly when to terminate streaming.

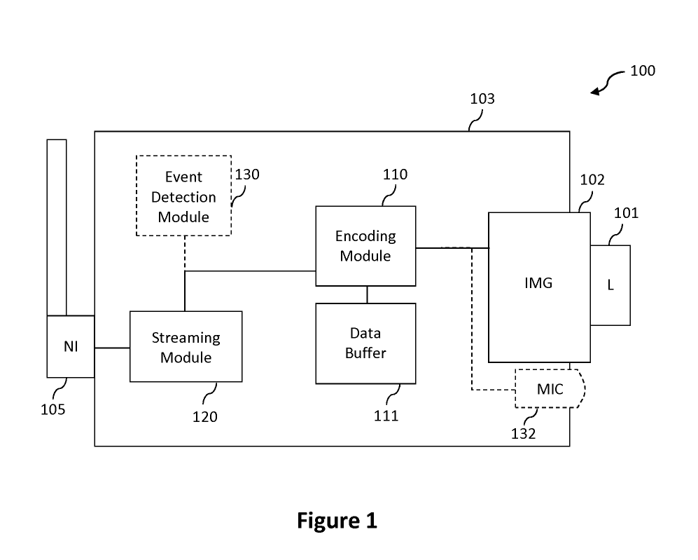

Accordingly, a preferred embodiment of the present invention comprises a camera assembly 100, as shown in FIG. 1. The camera assembly 100 may include a lens 101 and imager 102, a housing 103, an encoding module 110, a data buffer 111, a streaming module 120, and a network interface 105. The camera assembly 100 may also optionally include an event detection module 130. The lens 101 and imager 102 are cooperatively structured to continuously capture visual data of live events as they occur, i.e. such as to convert light and images into an electrical signal, which may comprise video data and/or snapshots data. Lens 101 may comprise normal, wide-angle, infrared, focus lenses or any other lenses of various construction and materials known to those skilled in the art. The imager 102 may comprise analog image sensors or digital image sensors. For example, imager 102 may a charge-coupled devices (CCD) image sensor, or complementary metal-oxide-semiconductor (CMOS) image sensor, or other imager, image sensor, or equivalents known to those skilled in the art. In at least one embodiment, the camera assembly 100 may also comprise a microphone 132, structured to capture audio data.

The encoding module 110 is structured and/or configured to write the captured video signal and/or snapshots and/or audio signal and/or metadata from the lens 101 and imager 102 and/or microphone 132 onto a storage medium such as the data buffer 111 (which may comprise volatile RAM memory or other appropriate technology). The encoding module 110 may comprise requisite processor(s), memory, and/or programmable logic to facilitate the recording. The encoding module 110 may further comprise internal distortion or noise controls, as well as controls for exposure, focus, color balance, and other image processing functions to enable and enhance the capture of observable images or video. Encoding module 110 may also comprise audio controls in embodiments comprising the capture of an audio signal. The encoding module 110 may also comprise software and/or hardware codecs that enable the recording of the captured video and/or audio signal in a compressed format, such as but not limited to MJPEG, MPEG4, H.264, H.265, VP8, VP9, OGG VORBIS, G.711, G.722.1, G.722.2, G.723.1, G.726, G.728, G.729, AAC, AC-3, WMA, and other video and/or audio codecs known to those skilled in the art. Encoding module 110 may also be configured to add metadata and/or one or more snapshots in the audio and/or video stream.

Data buffer 111 may comprise at least a portion of memory and/or storage on volatile or non-volatile storage or memory, including random-access memory (RAM), flash memory, magnetic hard disks, solid state drives, memristor, resistive random-access memory, and other equivalent storage known to those skilled in the art (though Volatile RAM may be preferred in certain cases). The present invention preferably stores the video and/or audio data and/or one or more snapshots and/or metadata in RAM or other volatile storage, as they are less likely to fail over time than non-volatile storage; however, other types of storage or memory may be used and may become preferable to volatile storage as circumstances permit. The present invention also preferably comprises a data buffer 111 located internally within the camera assembly housing 103; however, external data buffers may be also be utilized. The amount of data buffer 111, and corresponding length of time of video and/or audio data and/or one or more snapshots and/or metadata the data buffer 111 is able to buffer, can be chosen, at least in part by a cost-benefit decision based on the cost of the particular storage medium or memory as well as the anticipated use of the camera assembly 100 and captured data. By way of example only, a preferred data buffer may be able to or have the capacity to contain approximately 30 seconds of historic video and/or audio data and/or one or more snapshots and/or metadata. Various other typical embodiments may comprise a storage capacity anywhere between 5 seconds to 30 minutes of historic video and/or audio data and/or one or more snapshots and/or metadata, although a variety of other durations might apply under specific circumstances.

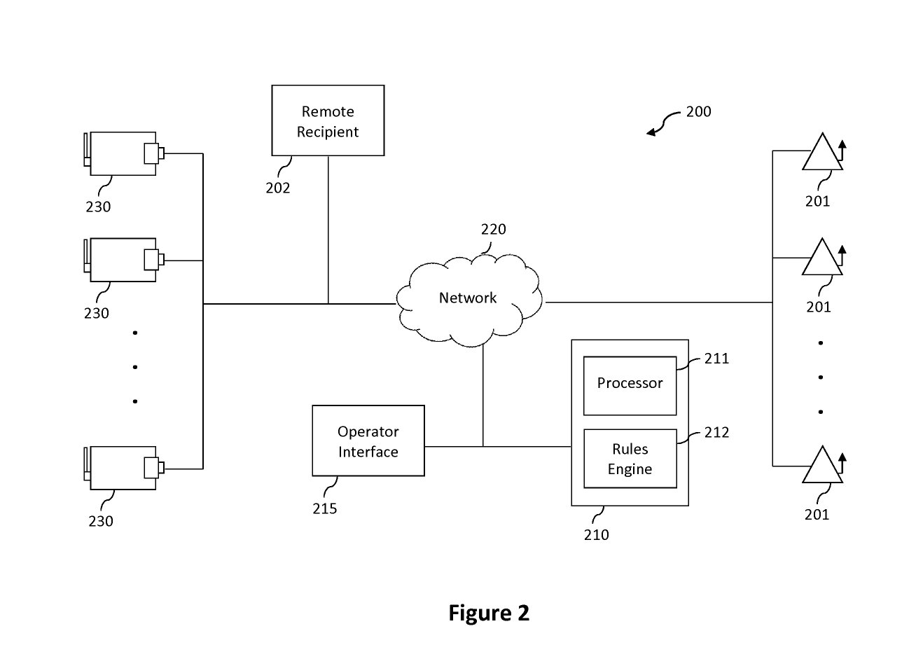

The streaming module 120 and network interface 105 are cooperatively structured and/or configured to stream the video data and/or one or more snapshots and/or audio data and/or metadata to at least one remote recipient, such as the exemplary remote recipient 202 depicted in FIG. 2. Accordingly, the streaming module 102 may comprise appropriate hardware and/or software to transmit historical video and/or one or more snapshots and/or audio data and/or metadata from the data buffer 111 at a recorded time prior to the current time, and for which a sufficient duration of the video data and/or audio data and/or one or more snapshots and/or metadata has been correspondingly stored. Ideally the streaming module will place a key frame from before the request time at the start of any new stream so the data received is usable from the first moment (otherwise without a key frame the beginning data may not be usable until the first key frame is received). Alternatively, streaming module 102 may also begin streaming the video and/or audio data and/or one or more snapshots and/or metadata in real time. Streaming module 102 may further comprise hardware and/or software codecs or devices configured to convert the video and/or audio data and/or one or more snapshots and/or metadata into a streaming format and/or to use various protocols, such as but not limited to MMS, RTSP, RTP, RTMP, Flash, HTTP, HTTPS, HTTP Dynamic Streaming or HTTP live streaming. The network interface 105 may comprise wired or wireless interfaces, such as but not limited to enable communication over WIFI, BLUETOOTH, NFC, radio, cellular networks, ETHERNET, cable, fiber optics, as well as other communication interfaces and mediums known to those skilled in the art. Streaming module 102 may begin streaming the video and/or one or more snapshots and/or audio data and/or metadata upon receiving a trigger signal, which preferably may be received by the control system running the rules engine such as through network interface 105.

The optional event detection module 130 may comprise appropriate hardware and/or software configured to detect a change or discrepancy in the video and/or audio data and/or one or more snapshots and/or metadata, or otherwise detect a change in the environment surrounding the camera assembly 100. Event detection module 130 may also provide metadata for events detected. Accordingly, the event detection module 130 may comprise of a video analytics engine and any number of sensors and scanners of any type including but not limited to infrared or visible optics, radio, sound, vibration, motion, temperature, and/or magnetism sensors configured to detect changes in the camera assembly's 100 surrounding environment. Upon detection of a change in the environment, i.e. detecting movement, the event detection module 130, in a preferred embodiment would act as an exemplary external device noted in 201 in FIG. 2 and notify the control system of the event for the control system to process and send a trigger signal back to one or more camera assemblies 100, to begin streaming the video and/or one or more snapshots and/or audio data and/or metadata from a time determined by the timestamp information in the trigger signal which may be a specific time or a relative time to the current time (such as a number of milliseconds before the trigger signal is received). Thereafter, the rules engine 212 can notify the camera assembly 230 when to terminate streaming. In other embodiments, the event detection module 130 may further transmit a trigger signal to the streaming module to begin streaming as described above.

As noted, above, another preferred embodiment of the present invention is directed to a system 200 for intelligent video capture and streaming, as illustrated by FIG. 2. The system 200 may comprise at least one camera assembly 230 as described above in detail (camera assembly 100), at least one remote recipient 202, and a control center 210 communicably connected over a network 220. The system 200 may further comprise at least one external device 201 also communicably connected to the network 220, as well as an operator interface 215 providing access to the control center 210. Any of the components of the system can be combined into a single device. A common embodiment is to combine the control system and remote recipient into a single piece of hardware such as a computer or embedded device. Further still, the control system 210, remote recipient 202, and external device 201 could all be embodied in the same application, or in separate applications running on a single physical device.

The camera assembly 230 preferably comprises the features and components generally discussed above regarding camera assembly 100, although it is within the scope of the present invention that camera assembly 230, may also comprise other cameras and/or camera assemblies structured to continuously buffer video and/or one or more snapshots and/or audio data and/or metadata of live events and store the video and/or one or more snapshots and/or audio data and/or metadata in a data buffer. Camera assembly 230 may be further structured to stream the video and/or one or more snapshots and/or audio data and/or metadata to at least one remote recipient 202 over the network 220, upon receiving a trigger signal that may be generated by control system running the rules engine. The camera assembly 230 may then begin streaming the video and/or one or more snapshots and/or audio data and/or metadata from the data buffer from a time prior to the current time, and for which a sufficient duration of the video data has correspondingly been stored in the data buffer.

The physical composition of the one or more remote recipient(s) 202 may comprise any combination of hardware and/or software configured to receive video and/or one or more snapshots and/or audio data and/or metadata from the camera assembly 230, and to record the incoming video and/or one or more snapshots and/or audio data stream and/or metadata. For example, remote recipient 202 may comprise a computer, a mobile device, wearable electronic devices, or other suitable devices that are structured and/or capable of receiving streaming video and/or one or more snapshots and/or audio data and/or metadata over a network. The remote recipient 202 may alternatively merely comprise a network interface and storage system configured to record all incoming data automatically, or at least partially automatically.

The one or more external device(s) 201 may comprise any combination of hardware and/or software configured to transmit an event signal to the control center 210, upon the occurrence of some event or a condition event. The trigger signal may be associated with a timestamp that may correspond to the condition event, and/or to the transmission or reception of the event signal, determined by the external device 201 and/or by the control center 210 described below. Accordingly, some examples of the external device 201 may comprise: a security alarm monitoring device or control panel, various sensors such as motion detectors, magnetic contacts, glass break detectors, photo electric detectors, smoke detectors, temperature sensors, as well as other state change detection devices or sensors, controls, scanners of any type, data sources, applications and cloud based and other services. External device 201 may be connected to the network 220, either directly or through other devices, such as to communicate or transmit an event signal to the control center 210. In some other embodiments, an external device 201 may be structured and/or configured to transmit an event signal directly to at least one camera assembly 230.

The control center 210 may comprise at least one general purpose computer or a specialized machine. For instance, the control center 210 of FIG. 2 comprises at least a processor 211 structured and/or configured to implement and/or execute a rules engine 212 configured to coordinate the issuance of the trigger signal, upon a desired condition. The rules engine 212 comprises at least a set of logic conditions. For example, if an alarm state is “ON” and if sensor A, i.e. one of the external devices 201 (which can alternatively be controls, applications, databases, services, etc.) is triggered, then a trigger signal is sent to camera A, i.e. a corresponding one of the camera assemblies 230, such as to capture and stream the video and/or one or more snapshots and/or audio data and/or metadata either live, or at a buffered time. The buffered time, as described above, may be invoked by a timestamp associated with the trigger signal sent by the control center 210. Thereafter, the rules engine 212 can notify the camera assembly 230 when to terminate streaming.

The timestamp may take a variety of forms, such as but not limited to, being the time a condition event is captured on an external device 201, the time an event signal is sent by the external device 201 to the control center 210, or the time the control center 210 receives such event signal, or a relative offset of any of those variety of forms or a relative offset of the time the camera receives the trigger signal, and may be based in part on the particular control center 210 and/or the external device(s) 201. In embodiments where each external device 201 keeps track of a timestamp for an event condition, the control center 210 or the overall system 200 may be further structured and/or configured to synchronize the time between each of the external devices 201 and camera assemblies 230, such as to provide an accurate capture and streaming of video and/or audio data and/or one or more snapshots and/or metadata. In embodiments where network connectivity is not an issue, timestamps may be omitted and/or may simply be the time the trigger signal is sent by the control center 210 and/or received by the camera assembly 230 (or a relative offset of that time, for example 12 seconds or 3700 milliseconds). A hybrid of timestamp determinations may be used, depending on the particular device and/or camera assembly in question.

The trigger signal may be relayed through other devices, possibly changing in format of structure as it is relayed. For example a trigger signal may be sent from the control system to remote recipient in the form of a remote procedure call. The remote recipient may then send a trigger in the form of an RTSP request to the camera where the timestamp is encoded into the RTSP URL. If the control system and remote recipient are in the same process space the initial trigger signal to be relayed may take the form of function call or event sent from the control system to the remote recipient and then to the camera. If the control system and remote recipient are on the same hardware but are in different process space the initial trigger signal may take any form known to those skilled in the art to communicate between process space. The trigger signal sent from the control system may also take the form of a request to the operating system, on the same device or remotely over a network, to initiate a new process instance of the remote recipient. The remote recipient upon executing then relays the trigger signal to the camera. In this way each remote recipient for each request of video and/or one or more snapshots and/or audio data and/or meta data may occupy its own process space and may not be running until required. In this way the trigger signal can be relayed as many times as necessary, changing form or not with each hop until it reaches the camera.

Again, once the streaming commences, the rules engine 212 can instruct the camera assembly 230 when to terminate streaming. For example, the rules engine 212 can provide instructions to stream for a predetermined amount of time, or a predetermined amount of time from a historical reference time, or until a specified future time, or until a condition is met as determined by the rules engine to terminate the streaming etc.

In at least one embodiment, the rules engine 212 may further be configured to determine which particular, or if all, remote recipient(s) will receive streaming video and/or audio data and/or one or more snapshots and/or metadata from a given camera assembly. In large complex monitoring frameworks, the rules engine 212 will thus allow certain camera assemblies 230 to stream only to certain remote recipients 202.

In at least one embodiment, a user will be able to modify the rules engine 212 located on the control center 210 either directly or remotely via an operator interface 215. The operator interface 215 may comprise hardware and/or software applications, such as user interfaces and communication protocols that enable a user to connect to modify the rules engine 212. The operator interface 215 may be partially embedded and/or integrated on either the control center 210 and/or the remote recipient 202 or other device.

As such, the operator interface 215 may be implemented as a software as a service (SaaS) housed on the control center 210 and/or a separate application server in communication with the control center 210. The operator interface 215 may be implemented in a number of different solution stacks when deployed as a SaaS. These solution stacks may include, without limitation, ZEND Server, APACHE Server, NODE.JS, ASP, PHP, Ruby, XAMPP, LAMP, WAMP, MAMP, WISA, and others known to those skilled in the art. More specifically, it should be understood the operator interface 215 may be implemented using any combination of operating systems, HTTP or other protocol servers, various security protocols (such as SSL), various different database servers, as well as different scripting or programming languages that make up the computer program including its logic, communications, and user interface(s). Alternatively, the operator interface 215 may also be deployed locally on the control center 210, coded in any number of programming languages for various operating systems known to those skilled in the art. As non-limiting examples, a user may be able to access the control center 210 and/or external devices 201 and/or camera assemblies 230 through a mobile device or computer through a web browser or application, and/or locally at the control center 210.

With continued reference to FIG. 2, the network 220 may comprise a computer or data network such as a LAN, WAN, Serial, ZWAVE, ZIGBEE, RS-485, MODBUS, BACNET, the Internet, over various wired and/or wireless mediums or any combination thereof including multiple of the same type connected by routers and/or gateways. Network 220 may further comprise additional hardware components and/or devices appropriate for facilitating the transmission and communication between the various systems and devices of the present invention, such as those directed to quality control or to improve content delivery.

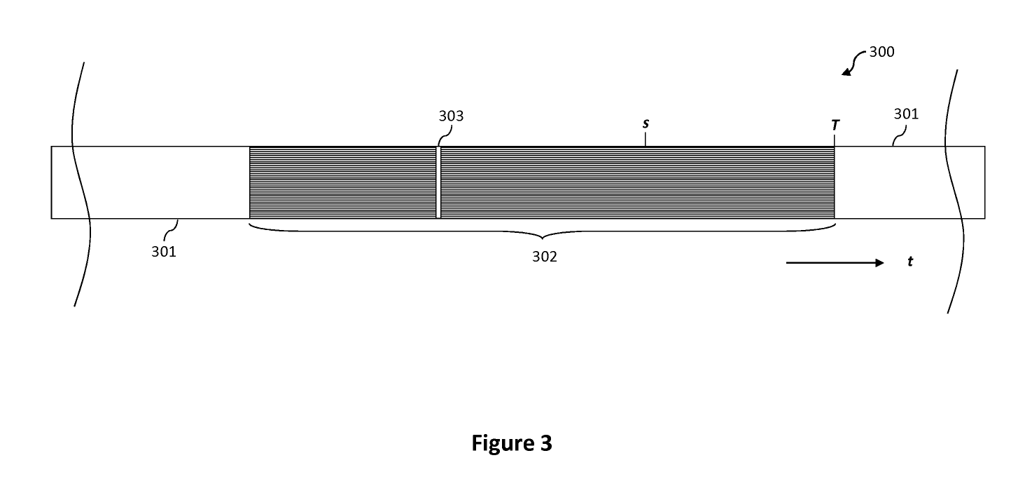

FIG. 3 provides a more detailed illustration of a data buffer 300 of various embodiments of the present invention over time t, as may be embodied in the camera assemblies 100, 230 of FIGS. 1 and 2, above. Accordingly, the data buffer 300 initially comprises unused memory 301 and recorded memory 302. Naturally, the unused memory 301 will not last long once the camera 100, 230 is operational; however it has been illustrated in FIG. 3 to be thorough as some uses might involve routine powering on and off of the cameras 100, 230. In the embodiments described above, a camera assembly 100 or 230 may be instructed as to when to begin streaming video and/or one or more snapshots and/or audio data and/or metadata from the data buffer 300.

As such, a camera assembly may begin streaming at a time when: t=T, which refers to the current or real time; t=s, which may refer to a timestamp transmitted by the control center 210, that may correspond to an event condition or event signal of an external device (including the camera itself) 201, or at when t=offset in time from when the trigger was sent or received 303. In at least one embodiment, the camera assembly 100 or 230 may be configured to begin streaming the video and/or one or more snapshots and/or audio data and/or metadata at a set time interval prior to the times determined by s or key frame 303 described above. This may be configured as a static feature on the one or more camera assemblies 100 or 230, or may more typically be configured to be transmitted as part of the trigger signal from the control center 210. In other embodiments, the control center 210 may determine another time to begin streaming the video and/or one or more snapshots and/or audio data and/or metadata from, this time may be requested by a user such as through an operator interface 215.

The data buffer 111, 300 recited above may comprise FIFO buffer, such as to continuously hold a predetermined amount of recorded video and/or one or more snapshots and/or audio data and/or metadata over a predetermined time interval, which may be dictated by the total physical capacity of onboard memory storage. In such an embodiment, when the memory buffer is full, recorded data from the previous recording cycle is then recorded over. Unused memory will all be used once the camera is running for a sufficient time. Thereafter, used memory will be overwritten, typically in a first in/first out (FIFO) manner. Recorded or “buffered” memory 302 would refer to the predetermined time interval of historic video and/or one or more snapshots and/or audio data and/or metadata that the camera assembly 100 or 230 recited above may begin streaming from.

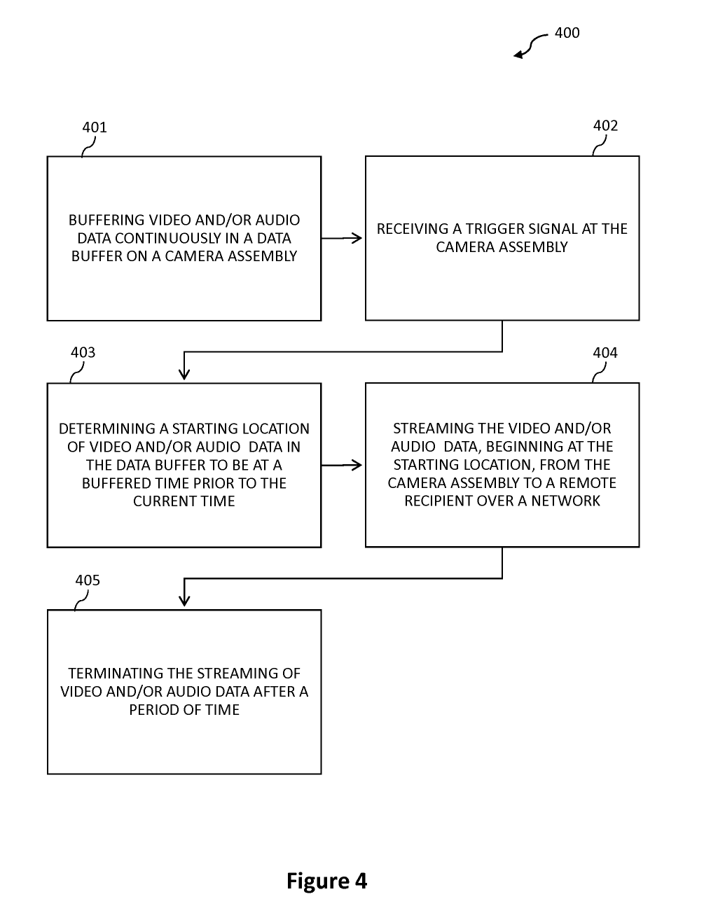

With primary reference now to FIGS. 4-6, various aspects of associated methods for intelligent video capture and streaming will be disclosed. First, as seen in FIG. 4, one such method comprises initial steps, at 401, of storing video and/or one or more snapshots and/or audio data and/or metadata continuously in a data buffer on a camera assembly. The camera assembly then, at 402, receives a trigger signal, most typically being an externally generated signal transmitted to the camera assembly (such as by the control center 210). The starting location of video data in the data buffer is then determined, as in 403, to be at a buffered time prior to the current time. The buffered time may be determined internally, or, more typically, may be determined by a timestamp (which may simply contain an offset in seconds or milliseconds, etc.) associated with the trigger signal generated by the control system, and received by the camera assembly. The video data (and/or audio data and/or data from any snapshots, metadata) is then streamed, as in 404, beginning at the starting location, from the camera assembly to a remote recipient over a network. After a period of time, the streaming of data is then terminated in accordance with the various options and parameters described above, as in 405.

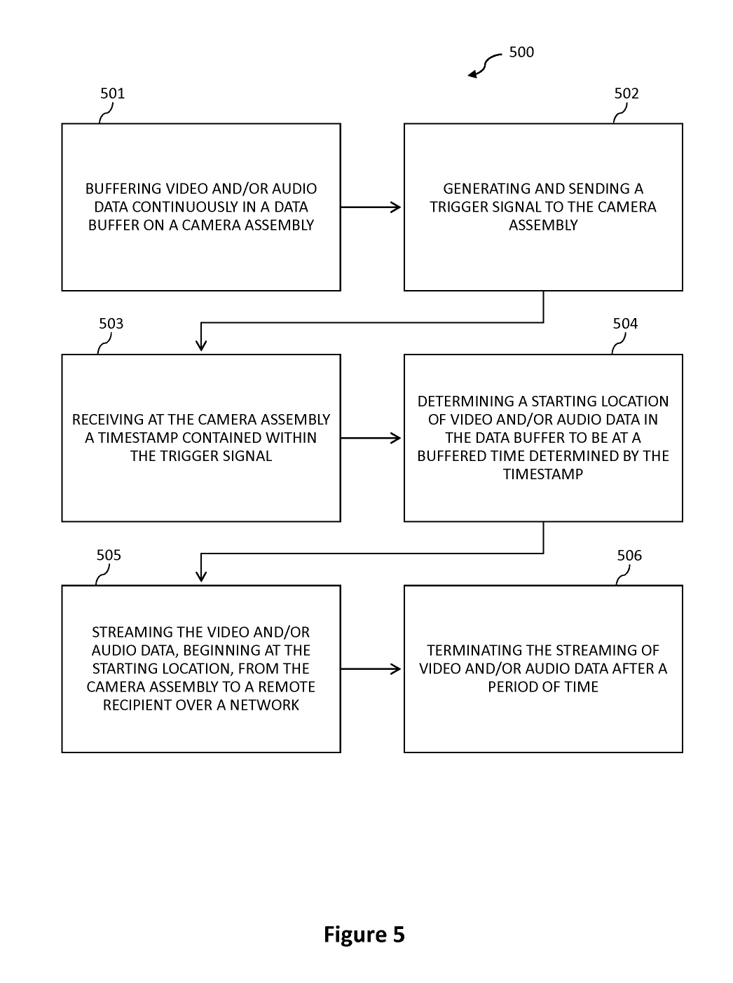

FIG. 5 is directed to yet another method for intelligent video capture and streaming in accordance with the present invention. This method comprises buffering, as at 501, video data (and/or audio data and/or data from any snapshots, metadata) continuously in a data buffer on a camera assembly. A trigger signal is generated and sent to the camera assembly, as in 502. The trigger signal and a time stamp associated with the trigger signal are received at the camera assembly, as in 503. A starting location of video data and/or one or more snapshots and/or audio data and/or metadata in the data buffer is then determined, as in 504, to be at a buffered time determined by the timestamp. The data is then streamed, as in 505, beginning at the starting location, from the camera assembly to a remote recipient over a network. After a period of time, the streaming of data is then terminated in accordance with the various options and parameters described above, as in 506.

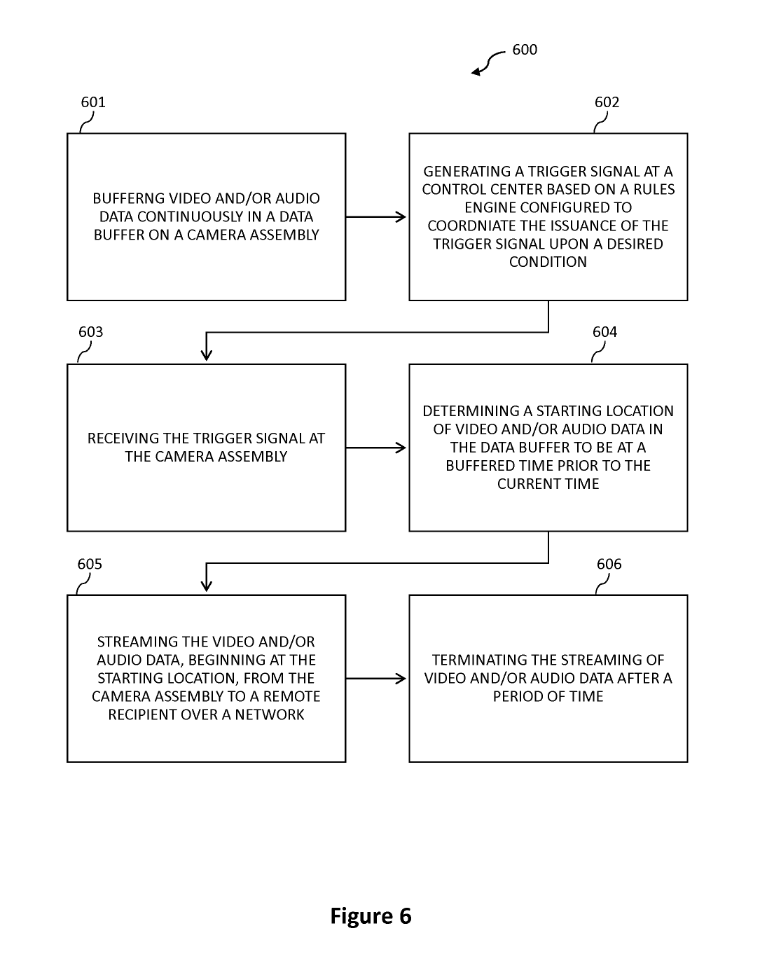

FIG. 6 is directed to still another method for intelligent video capture and streaming in accordance with the present invention. This method comprises buffering, as in 601, video data (and/or data from any snapshots, audio data, metadata) continuously in a data buffer on a camera assembly. A trigger signal is then generated at a control center based on a rules engine configured to coordinate the issuance of the trigger signal upon a desired condition, as in 602. The trigger signal is received at the camera assembly, as in 603. A starting location is then determined of video data in the data buffer, as in 604, to be at a buffered time prior to the current time. The video data is then streamed, as in 605, beginning at the starting location, from the camera assembly to a remote recipient over a network. After a period of time, the streaming of data is then terminated in accordance with the various options and parameters described above, as in 606.

In various embodiments, the above methods depicted in FIGS. 4-6 may be performed in different order, and in some cases various steps may be omitted, while other steps may be included. Moreover, various devices and/or components may be utilized to implement the above methods, including those described above in FIGS. 1-3, such as the camera assembly 100 and the system 200 (or relay points that are added to the system or are part of any existing components).

Further, in place of mere video data, other relevant types of data, such as combined video and/or audio data and/or image snapshot(s) along with any associated metadata with any media and/or data type being transmitted and/or streamed, may be transmitted and/or streamed in any of the above method embodiments and/or embodiments directed to the camera assembly 100 and system 200 and methods 400, 500, 600, for intelligent video capture and streaming.

By way of narrative examples, two scenarios are provided next for illustrative purposes, though by no means are they intended to be construed as the only applicable scenarios.

SCENARIO 1 (involving different processes): User uses operator interface to configure rules operating on the control system that state:

“When the alarm system is armed and the front door motion sensor detects motion then start recording the front door camera starting 10 seconds ago and continue recording for 2 minutes and start recording on the outside camera starting 15 seconds ago and continue recording for 1 minute.”

The control system then receives the state of the alarm system as armed and later receives a motion event from motion sensor.

Control system then tells the operating system (WINDOWS for example) to initiate 2 new processes of remote recipient (one for each camera), in the command to initiate the processes the control systems passes along the offset time to the process of how long ago it should request the time from the cameras. The remote recipients then turns these instructions into RTSP commands to send to cameras.

The cameras respond by streaming the respective data to the remote recipient, remote recipient records the video as it is received.

The control system then sends a notification to the remote recipient processes when it is time to stop recording and they terminate the recording (or it could alternatively just terminate the processes so that the cameras would stop streaming since they do not receive acknowledgements that their video is being received, though this second option is perhaps less efficient as the cameras would continue streaming for a while; whereas a command being sent to the cameras to terminate the streams would be immediate).

SCENARIO 2 (involving one or more functions within the same process): User uses operator interface to configure rules operating on the control system that state:

“When the alarm system is armed and the front door camera starts detecting motion through video analytics then send a snapshot from 3 seconds ago from the front door camera and send a snapshot from 10 seconds ago from the outside camera.”

The control system then receives the state of the alarm system as armed and later receives a motion event from the front door camera.

Control system then calls a function (remote recipient in the same process space) which sends an HTTP request to the cameras containing a request for a snapshot from the previous point in time as directed by the rules.

The camera responds by sending the snapshots back via HTTP to the remote recipient (which is actually in the same process space and the same computer as the control system in this scenario).

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A camera assembly for intelligent video capture and streaming, said camera assembly comprising:
a lens and imager cooperatively structured to continuously capture at least visual data of live events, wherein said visual data may comprise video data and/or snapshot data;
an encoding module configured to format and continuously feed at least said visual data to a data buffer; and
a streaming module configured to stream at least said visual data to at least one remote recipient over a network via a network interface,
wherein said streaming module is configured to begin streaming at least said visual data from said data buffer at a location in buffered time prior to the current time, and for which a sufficient duration of at least said visual data has correspondingly been stored.

2. A camera assembly as recited in claim 1 wherein said streaming module is further configured to stream audio data, and/or metadata associated with said visual data.

3. A camera assembly as recited in claim 1 further comprising an event detection module configured to send an event notification to a control system upon detecting an event.

4. A camera assembly as recited in claim 1 wherein said streaming module is further configured to receive a trigger signal and to initiate said streaming upon processing of said trigger signal.

5. A camera assembly as recited in claim 4 wherein said streaming module is further configured to process a timestamp contained in said trigger signal.

6. A camera assembly as recited in claim 5 wherein said timestamp comprises an absolute time reference.

7. A camera assembly as recited in claim 6 wherein said trigger signal containing said timestamp is used to determine a time prior to a current time from which to begin streaming.

8. A camera assembly as recited in claim 5 wherein said timestamp comprises a relative offset in time.

9. A camera assembly as recited in claim 8 wherein said trigger signal containing said timestamp is used to determine a time prior to a current time from which to begin streaming.

10. A camera assembly as recited in claim 1 wherein said streaming module is further structured to receive a termination signal to stop streaming of at least said visual data.

11. A camera assembly as recited in claim 1 wherein said streaming module is further structured to stop streaming when said streaming module ceases to receive a heartbeat message or other form of acknowledgment from the remote recipient.

12. A system for intelligent video capture and streaming, said system comprising:
at least one camera assembly communicably connected to a network,
said at least one camera assembly structured to continuously buffer at least visual data of live events in a data buffer, wherein said visual data may comprise video data and/or snapshot data,
said at least one camera assembly further structured to stream at least said visual data to at least one remote recipient over said network, upon receiving a trigger signal,
wherein said at least one camera assembly is configured to begin streaming at least said visual data from said data buffer at a location in buffered time prior to the current time, and for which a sufficient duration of at least said visual data has correspondingly been stored; and
a control center comprising at least one processor structured to run at least a portion of a rules engine, wherein said rules engine is configured to coordinate the issuance of the trigger signal, upon a desired condition.

13. A system as recited in claim 12 wherein said at least one camera assembly is further configured to buffer audio data and/or metadata associated with said visual data and to stream said audio data and/or metadata in conjunction with said visual data.

14. A system as recited in claim 12 further structured to relay the trigger signal through at least one device.

15. A system as recited in claim 14 wherein said relay device comprises an application initiated thereon to relay the trigger signal.

16. A system as recited in claim 14 wherein said application is structured to process a relay command contained in the trigger signal.

17. A system as recited in claim 12 wherein said at least one camera assembly further comprises an event detection module configured to send an event notification to said control system upon detecting an event.

18. A system as recited in claim 12 wherein said at least one camera assembly is further configured to process a timestamp contained in said trigger signal.

19. A system as recited in claim 18 wherein rules in said rules engine at least partially determine said timestamp.

20. A system as recited in claim 18 wherein said timestamp comprises an absolute time reference.

21. A system as recited in claim 18 wherein said timestamp comprises a relative offset in time.

22. A system as recited in claim 12 wherein said trigger signal contains a timestamp used to determine a time prior to a current time from which to start streaming data from a data buffer.

23. A system as recited in claim 12 wherein said at least one camera assembly is further structured to receive a termination signal to stop streaming of at least said visual data.

24. A system as recited in claim 12 further structured to stop streaming when said camera assembly no longer receives a heartbeat message or acknowledgments from a stream recipient.

25. A system as recited in claim 12 further comprising at least one external device communicably connected to said network, wherein said at least one external device is structured to transmit an event signal over said network to said control center upon a condition event.

26. A system as recited in claim 25 further structured to relay the event signal through at least one device.

27. A system as recited in claim 26 further structured to change a format of the event signal as the event signal is relayed.

28. A system as recited in claim 12 wherein said at least one camera assembly is further configured to process a timestamp contained in said trigger signal.

29. A system as recited in claim 28 wherein said timestamp is at least partially determined by said at least one external device.

30. A system as recited in claim 29 wherein said timestamp incorporates of is calculated using the time said condition event occurred on said at least one external device.

31. A system as recited in claim 12 further comprising an operator interface structured to modify said rules engine of said control center.

32. A system as recited in claim 31 wherein said desired condition is configurable from said operator interface.

33. A system as recited in claim 31 wherein said rules engine comprises a plurality of desired conditions that are configurable from said operator interface.

34. A system as recited in claim 31 wherein said at least one remote recipient is selectable from said operator interface.

35. A system as recited in claim 31 wherein said timestamp is at least partially calculated using rules configured from said operator interface.

36. A method for intelligent video capture and streaming, the method comprising:
buffering at least visual data of live events continuously in a data buffer on at least one camera assembly, wherein said visual data may comprise video data and/or snapshot data,
receiving a trigger signal at the at least one camera assembly,
in response to the trigger signal, determining a starting location of at least visual data in the data buffer, the starting location being at a moment in buffered time prior to the current time, and
streaming at least the visual data, beginning at the starting location, from the at least one camera assembly to a remote recipient over a network.

37. A method as recited in claim 36 further comprising buffering audio data and/or metadata associated with the visual data and streaming the audio data and/or metadata and/or snapshot data in conjunction with the visual data.

38. A method as recited in claim 36 further comprising receiving a timestamp associated with the trigger signal at the camera assembly and utilizing the timestamp to determine the starting location of the at least visual data.

39. A method as recited in claim 36 further comprising receiving a termination signal to stop streaming at least said visual data.

40. A method as recited in claim 36 further comprising terminating the stream if a heartbeat signal or acknowledgments are no longer received.

41. A method as recited in claim 36 further comprising generating the trigger signal at a control center based at least partially on a rules engine, the rules engine being configured to coordinate the issuance of the trigger signal upon a desired condition.

42. A method as recited in claim 41 further comprising relaying the trigger signal through at least one device.

43. A method as recited in claim 42 further comprising changing the format of the trigger signal as it is relayed.

44. A method as recited in claim 41 further comprising configuring the rules engine through an operator interface.

45. A method as recited in claim 41 further comprising configuring the desired condition through an operator interface.
